(19) United States
(12) Patent Application Publication
(10) Pub. No.: US 2025/0138484 A1
(43) Pub. Date: May 1, 2025

(54) WATCH CONTROL DEVICE

(71) Applicant: Omega SA, Biel/Bienne (CH)

(72) Inventors: Philippe LOETSCHER, Evilard (CH); Félicien VILLARD, Bienne (CH)

(73) Assignee: Omega SA, Biel/Bienne (CH)

(21) Appl. No.: 18/808,581

(22) Filed: Aug. 19, 2024

(30) Foreign Application Priority Data
Oct. 25, 2023 (EP) 23205763.8

(51) Int. Cl. G04B 27/00

(52) U.S. Cl. CPC G04B 27/002

(57) ABSTRACT

A control device (1) for a watch including a crown (2) mounted movably in a support part (3) of this device (1) and intended to be fixed with respect to the movement of the watch, the crown (2) being capable of being displaced axially with respect to its longitudinal axis (A) towards a control position in which a rotational drive element (8) of the crown (2) is capable of cooperating with a ring (10) mounted movably in a casing ring (29) of a control member (4) of the device (1), the ring (10) being configured to actuate a mechanism of the watch movement implementing a function of the watch when the crown (2) is rotated.

### CROSS REFERENCE TO RELATED APPLICATION

This application claims priority to European Patent Application No. 23205763.8 filed Oct. 25, 2023, the entire contents of which are incorporated herein by reference.

### TECHNICAL FIELD OF THE INVENTION

The invention relates to the field of watchmaking, and in particular to watch control devices.

### TECHNOLOGICAL BACKGROUND

In the prior art, control devices such as push-buttons are used on certain watches, in particular so-called “grandes complications” watches, which can feature a large number of functions. These push-buttons are of various types, including miniature push-buttons which are typically embedded in the watch middle.

Such miniature push-buttons are typically very small, which saves space, particularly in the case enclosure of these watches. What is more, they do not protrude from the middle, and so there is no risk of accidental operation.

However, one of the disadvantages of such push-buttons is that they necessarily require the use of a pointed actuating tool when operations are to be carried out to control a watch function, such as setting the time, date, moon phase or calendar. Such use entails a considerable risk of damage to the watch case, and therefore of altering the aesthetic appearance of this case.

Under these conditions, it is understandable that there is a need to find a solution to overcome these disadvantages of the prior art.

### SUMMARY OF THE INVENTION

One of the objects of the invention is to provide a control device for a watch, allowing the functions of the watch to be controlled without the need for an actuating tool.

Another object of the invention is to reduce or eliminate the need for a push-button in the watch case middle.

The invention relates to a control device for a watch comprising a crown mounted movably in a support part of this device and intended to be fixed with respect to the movement of the watch, said crown being capable of being displaced axially with respect to its longitudinal axis towards a control position in which a rotational drive element of said crown is capable of cooperating with a ring mounted movably in a casing ring of a control member of said device, said ring being configured to actuate a mechanism of the watch movement implementing a function of the watch when the crown is rotated.

In other embodiments:
the casing ring comprises on its inner peripheral wall a cooperation zone between the ring and the drive element, said zone comprising stop elements defining a displacement travel of this ring mounted movably in the casing ring;
the drive element has a free end comprising a coupling portion for coupling to the ring;
the coupling portion extends substantially perpendicularly to an outer surface of said free end;
the casing ring comprises a through-hole interconnecting inner and outer peripheral walls of said casing ring, the hole having a passage zone for said free end;
the passage zone comprises a central portion configured for the arrangement of a main part of the free end in said hole and an eccentric portion forming a passage allowing the coupling portion to pass through the body of said casing ring;
the ring comprises an actuating element for a pivoting element of the member configured to actuate the mechanism implementing the function of the watch;
the control member comprises a first elastic return element configured to automatically return the ring to a rest position;
the drive element is integral with a head of the crown.

Another aspect of the invention relates to a watch comprising such a control device.

### BRIEF DESCRIPTION OF THE FIGURES

Other features and advantages of the invention will become clearer on reading the following description of a particular embodiment of the invention, given merely as an illustrative and non-limiting example, and from the accompanying figures, in which:

FIGS. 1 and 2 show different views of the device for controlling at least one function of a watch, according to one embodiment of the invention;

FIG. 3 shows a view of a crown of the control device arranged in an “initial” axial position, according to the embodiment of the invention;

FIGS. 4 and 5 show views of the crown of the control device arranged in an axial “control” position in which rotation of this crown brings about at least one function of the watch, according to the embodiment of the invention;

FIGS. 6a and 6b show a view of a portion of an outer peripheral wall of a casing ring of a control member of the control device, said portion comprising a through-hole having at least one passage zone for a free end of a crown drive element for controlling at least one function of the watch, according to the embodiment of the invention;

FIG. 7 shows a view of the portion of the outer peripheral wall of the casing ring when the free end of the rotational drive element is inserted into the corresponding passage area of the through-hole for controlling at least one function of the watch, according to the embodiment of the invention, and

FIGS. 8 and 9 show views of the crown in its control position after the crown has been rotated to control said at least one function, according to the embodiment of the invention.

### DETAILED DESCRIPTION OF THE INVENTION

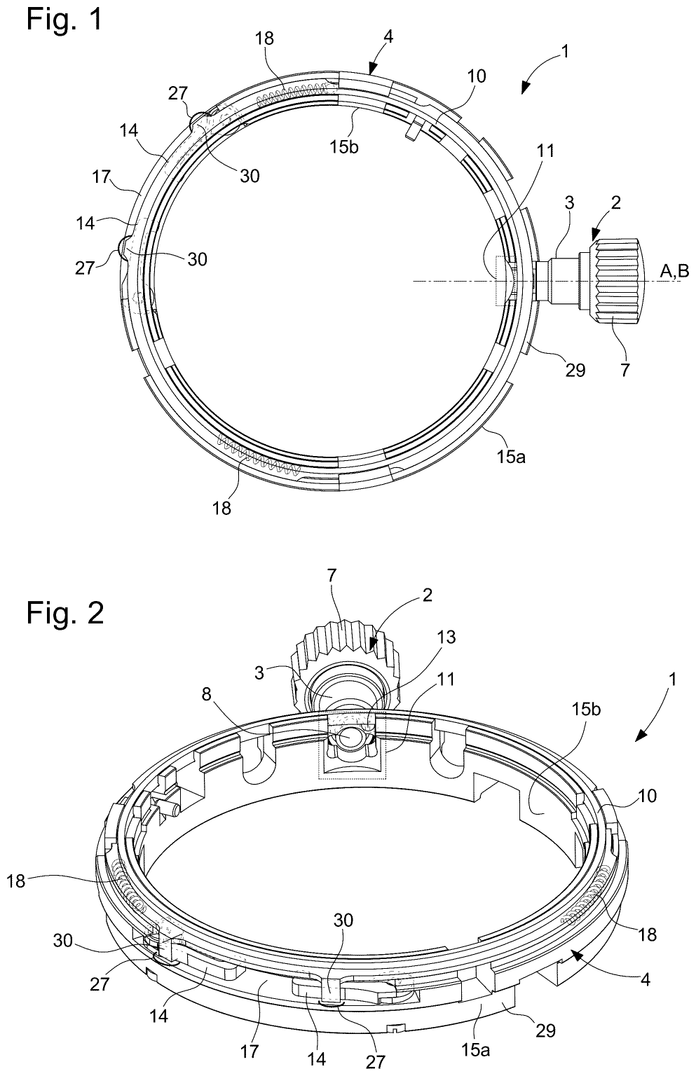

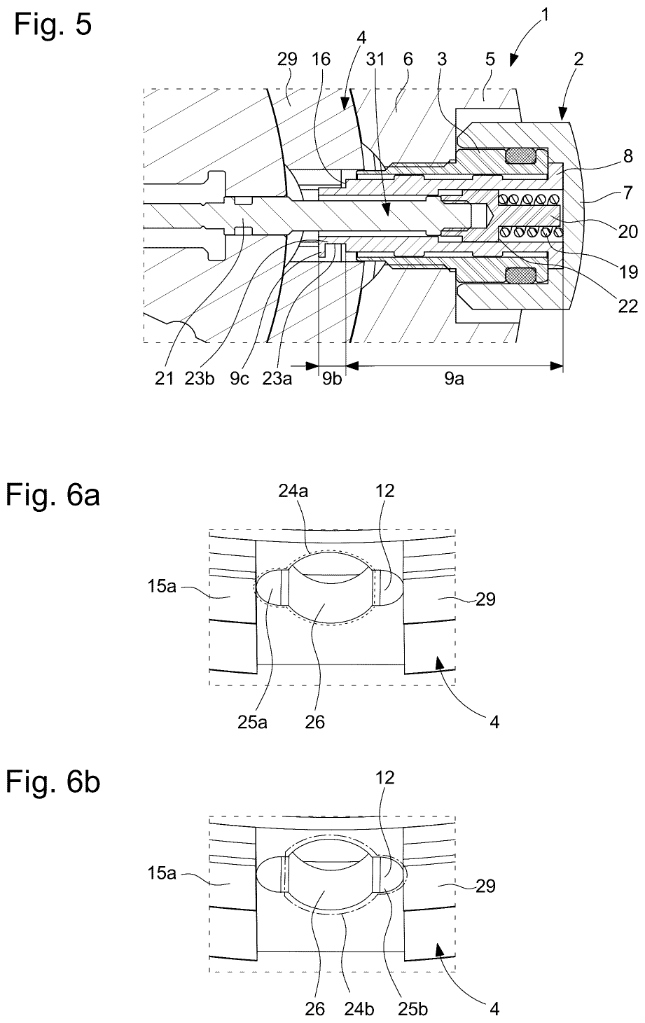

With reference to FIGS. 1 to 9, the present invention relates to a watch, also called timepiece, such as a wristwatch comprising a control device 1 for at least one function which is implemented by a watch movement included in this watch. Such a watch typically comprises a case 5 formed by a preferably circular middle 6, defining a central internal housing designed to receive the watch movement, the external contour of which follows the internal shape of a casing ring 29. This watch can be fitted with screws or clamps to hold the movement in this casing ring 29 and also to hold this casing ring 29 in the middle 6 of the watch case 5.

Such a watch movement may be mechanical or quartz. As shown previously, this movement is configured to implement at least one watch function, and in the present embodiment two watch functions. These functions are controlled from the control device 1 for the purpose of adjusting, correcting or activating mechanisms of this movement. Note that such functions are preferably controlled independently of each other by a user from this watch control device 1. In this context, this device 1 may be considered as a control device 1 of a mechanism of the movement, implementing a watch function.

It is understood that this movement is adapted to carry out the functions, in particular from the separate mechanisms of the movement that can be kinematically linked together. By way of example, each mechanism may lead in practice to a separate display on the watch, such as the display of the current time on the one hand and a date or moon phase on the other. The movement and its functions are controlled and/or monitored via the control device 1.

For this purpose, the control device 1 for functions of the movement comprises a support part 3, a crown 2, a control member 4 and a tension member 31.

In this device 1, the support part 3, which may also be referred to as the “support and guide part”, is preferably a tube with a through-opening configured for sliding guidance. This tube is designed to be fixedly engaged in a radially extending through-hole in the watch middle 6. In this configuration, this part 3 is thus arranged fixedly with respect to the watch movement.

For its part, the crown 2 is mounted movably in this opening in the support part 3. Such a crown 2 is intended to be engaged through the middle 6 of the case 5 of this watch by means of the support part 3. This crown 2 may take the form of a push-button crown, a winding crown or any crown 2 used to operate the watch movement. This crown 2 comprises a crown head 7, and a rotational drive element 8 which is formed by a tubular extension integral with this head 7.

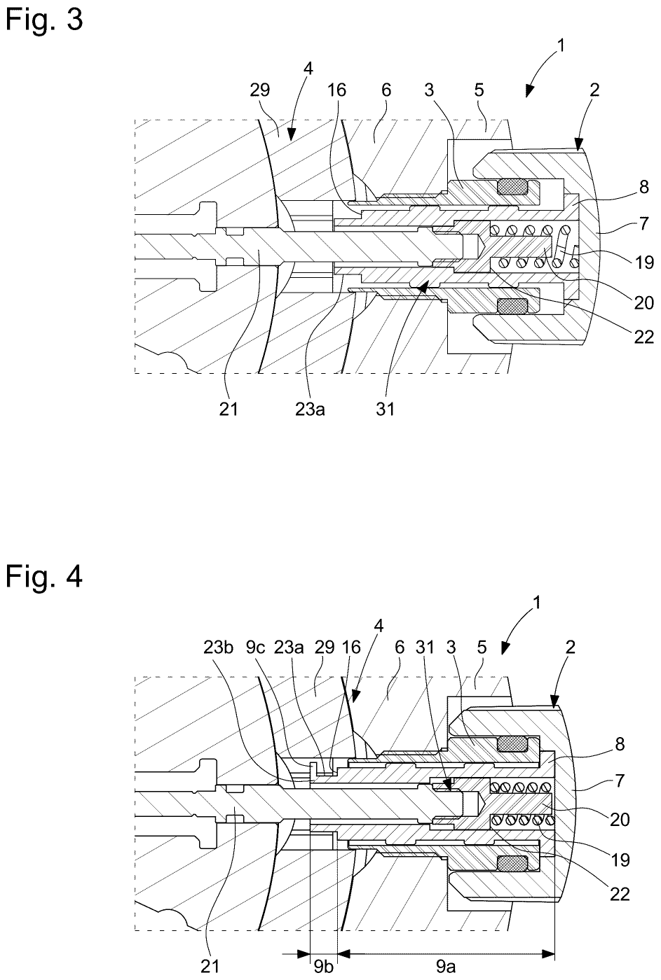

In this crown 2, the drive element 8 is arranged essentially in the support part 3 and is also configured to be moved or slid through the opening in this part 3. More precisely, the drive element 8 comprises a body made up of three portions, namely: a fixing portion 9a connected to the head 7 of the crown 2, an insertable portion 9b capable of being introduced into the through hole 12 and a coupling portion 9c configured to cooperate with the control member 4 in order to participate in the control of one of the functions of the watch. In the hollow body of this drive element 8, the insertable portion 9b is arranged after the fixing portion 9a. These two portions 9a, 9b are also connected to each other by a shoulder 16 formed on the outer surface of the body of this drive element 8, as can be seen in FIGS. 3 to 5. The insertable portion 9b consists of a main part 23a and of a terminal part 23b. In this configuration, the main part 23a is located between the shoulder 16 and the end part 23b.

In this drive element 8, the coupling portion 9c extends perpendicularly to an outer surface of the insertable portion 9b. More particularly, this coupling portion 9c extends substantially perpendicularly to a zone of this surface included in the end part 23b of the insertable portion 9b. In other words, this coupling portion 9c extends substantially perpendicularly to the longitudinal axis A of the crown 2.

Thus, the insertable and coupling portions 9b, 9c together form a free end of the drive element 8. In other words, such an end is then formed by the main and terminal parts 23a, 23b and also by the coupling portion 9c. In this context, coupling portion 9c therefore extends substantially perpendicularly to the surface of this free end.

In addition, the fixing portion 9a of the drive element 8 can be driven into the head 7 of the crown 2, or made integral therewith. As previously mentioned, this drive element 8 comprises a shoulder, with the reference sign 16 in FIGS. 3 to 5, which connects the fixing and insertable portions 9a, 9b to each other. Such a shoulder 16 preferably has a flat surface. Note that such a surface is also substantially perpendicular to the longitudinal axis A of the crown 2.

As mentioned above, in this device 1, the rotational drive element 8 is able to cooperate with the actuating member 4. Such a member 4 is preferably configured to be connected to the watch movement, in particular when a mechanism of this movement is activated to perform a watch function. For this purpose, this member 4 comprises the casing ring 29, a ring 10, at least one first elastic return element 18 and at least one movable actuating element 30.

In this member 4, the casing ring 29 may have a variety of shapes inasmuch as it surrounds the watch movement and is positioned inside the middle 6 of the case 5. In the present embodiment, this casing ring 29 is preferably substantially circular. Such a casing ring 29 comprises top and bottom faces and inner and outer peripheral walls connecting these two faces together.

In this configuration, the top face of the casing ring 29 comprises a support zone designed to accommodate or receive the ring 10 as part of its arrangement in this casing ring 29. This support zone comprises a flat surface of which the lateral edges are wholly or partially raised along the entire length of this zone, in order to ensure that the ring 10 is held and guided on this surface, in particular when this ring 10 moves. Such a surface of the support zone also comprises an open housing configured to receive each first elastic return element 18 of this member 4. In this configuration, the first elastic return element 18, which may be a helical spring, is arranged below the ring 10. As will be shown later, the first elastic return element 18 is designed to automatically return the ring 10 to its rest position after it has been activated to control a watch function.

The casing ring 29 of this member 4 also comprises a through-hole 12 connecting its inner and outer peripheral walls 15a, 15b to each other. Such a hole 12 comprises a central axis B which coincides with the longitudinal axis A of the crown 2. In this configuration, the geometry of this hole 12 and its location in the casing ring 29 are defined so that the drive element 8 can pass through it. This hole 12 comprises at least one passage zone 24a, 24b for the free end of drive element 8 to control at least one function of said watch.

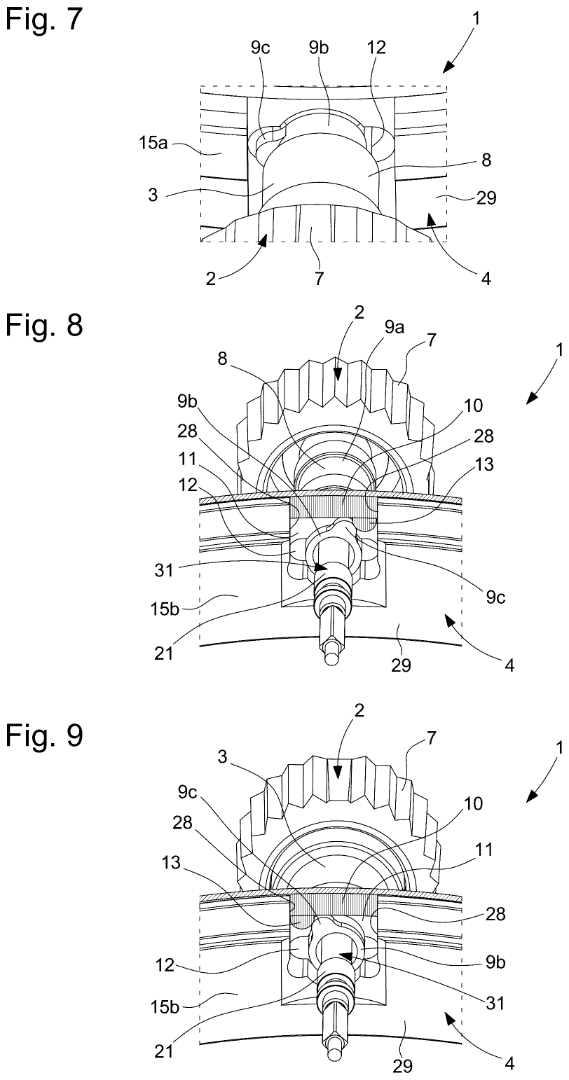

Referring to FIGS. 6a, 6b and 7, this hole 12 has first and second passage zones 24a, 24b, each configured to control a watch function. In other words, these two passage zones 24a, 24b allow such a through-hole 12 to be structurally configured to control two watch functions. In this context, each passage zone 24a, 24b comprises a central portion 26 configured for the arrangement of the main part 23a of the insertable portion 9b and thus of the free end in the through-hole 12, and an eccentric portion 25a, 25b configured for the passage of the coupling portion 9c through this hole 12. This eccentric portion 25a, 25b forms a passage allowing the coupling portion 9c to pass through the body of said casing ring 29 as far as a cooperation zone 11 defined in the inner peripheral wall 15b, which will be discussed later. In this context, it will be understood that the two passage zones 24a, 24b share the same central portion 26. In other words, the central portions 26 of these two zones 24a, 24b are coincident. In this configuration, the central portion 26 extends over a distance from the outer peripheral wall 15a to the inner peripheral wall 15b of the casing ring 29, this distance being substantially less than the length of the main part 23a of the insertable portion 9b. A distance that is “substantially less” means that this distance is “strictly less” or “substantially less” than the length of the main part 23a.

The casing ring 29 also comprises a through-opening 17 forming a housing for receiving at least one pivoting element 14, such as a rocker, which can be actuated by the ring 10 in order to interact with the movement mechanism implementing the function. This casing ring 29 comprises a second elastic return element and a retaining element which are arranged in this housing and which are intended to cooperate with the pivoting element 14 in order, in particular, to configure it in an initial rest position. This pivoting element 14 then alternates between the initial position and an activation position in which part of this element 14 protrudes from the inner peripheral wall 15b of the casing ring 29 in order to interact with the mechanism implementing the function to be controlled. The arrangement of this pivoting element 14 in the activation position is controlled by the ring 10 and in particular by an actuating element 30 of this ring 10. It should be noted that this pivoting element 14 moves from the activation position to the initial position under the action of the second elastic return element, which causes this pivoting element 14 to move in a direction opposite to that intended to bring it to its activation position, until this element 14 comes into abutment against the retaining element.

As mentioned above, the casing ring 29 comprises a cooperation zone 11 between the rotational drive element 8 and the control member 4. More precisely, this zone 11 is where the coupling portion 9c of the drive element 8 cooperates with a coupling element 13 of the ring 10 to cause the ring 10 to move in the casing ring 29. Such a zone 11 is included on the inner peripheral wall 15b of the casing ring 29. This zone 11 includes in particular a portion of this peripheral wall 15b into which the through-hole 12 opens. In this configuration, the zone 11 has stop elements 28 which are capable of cooperating with the coupling element 13 of the ring 10 so as to define the displacement travel of the movable ring 10 in the casing ring 29.

In this device 1, the ring 10, also known as the “movable ring”, has a shape that is configured to ensure its arrangement and movement in the support zone of the casing ring 29. In the present embodiment, this ring 10 has a shape that is substantially circular. This ring 10 comprises top and bottom faces and inner and outer lateral faces.

As previously mentioned, the ring 10 comprises said at least one actuating element 30, the coupling element 13, at least one connecting element for connecting to the first elastic return element 18. This ring 10 comprises as many actuating and connecting elements 30 as the control device 1 is able to control functions. More precisely, when this control device 1 is configured to control a single function, the ring 10 comprises a single actuating element 30, a single coupling element and a single connecting element. In this context, the casing ring 29 then comprises a single first elastic return element 18. If this device 1 is configured to control two functions, then the ring 10 comprises two actuating elements 30, a single coupling element 13 and two connecting elements capable of cooperating with two different first elastic return elements 18, as illustrated in FIGS. 1 and 2.

In this ring 10, this actuating element 30 of the pivoting element 14 is included on the outer lateral face of the ring 10. This actuating element 30 is configured to extend towards a region 27 of the housing accommodating the pivoting element 14, said region being located close to this pivoting element 14 to be actuated. In other words, this actuating element 30 extends substantially vertically towards this region 27 and opposite the pivoting element 14. It will be understood that the location of the actuating element 30 in this region 27 of the housing allows this actuating element 30 to be arranged in the immediate vicinity of the pivoting element 14. Such an arrangement allows activation of this pivoting element 14 by this actuating element 30 so that it can move from its initial position to its activation position. This actuating element 30 projecting from the outer lateral face of the ring 10 has a shape substantially similar to that of the letter “L”, being formed by a first portion substantially perpendicular to this face and a second portion which is substantially parallel to this same face, said portions being substantially perpendicular to each other.

This ring 10 also comprises a connecting element for connecting to the first elastic return element 18 arranged in a housing included in the support zone of the casing ring 29. This connecting element is located on the bottom side of this ring 10. This element extends substantially perpendicularly from this bottom side towards the bottom of the corresponding housing comprising this first elastic return element. In other words, this connecting element is partly arranged in this housing of the support zone, between a first end of the first elastic return element 18 and a wall of this housing. This connecting element has a shape that is configured to apply or exert a constraining force on this first end with which it is in contact, the second end of this first return element 18 being able to be in contact with or to bear on a support wall of this housing that is arranged opposite this connecting element. It will be understood that in this configuration, since the connecting element is partly located in the housing, it can therefore be moved within the enclosure of this housing to compress this return element 18 when the ring 10 is in motion.

Referring to FIGS. 2, 8 and 9, the coupling element 13 of the ring 10 is located on the inner lateral face of this ring 10. This element 13, which is preferably integral with the body of the ring 10, forms a relief on this face which is substantially polygonal in shape. This shape is particularly suitable for achieving optimum coupling to the coupling portion 9c of the drive element 8.

As mentioned previously, the device 1 also includes a tension member 31 which is configured to improve cooperation between the coupling portion 9c and the coupling element 13, in order to ensure optimum displacement of the ring 10 in the support zone of the casing ring 29. More precisely, such a member 31 helps to maintain the contact established between the coupling portion 9c and the inner lateral face of the ring 10 and therefore the surface of the cooperation zone 11 in order to ensure that the coupling between the coupling portion 9c and the coupling element 13 is achieved as part of the movement of the ring 10 in the casing ring 29. Such a tension member 31 then comprises a spring 19 which is mounted freely in a cylindrical housing defined by the fixing portion 9a of the drive element 8 fixed to the head 7 of the crown, and also a compression part 20 of this spring 19 bearing on a stem 21, for example a watch winding and setting stem. This part 20 comprises a shoulder 22 forming a support zone for a first end of the spring 19, the shoulder 22 being located opposite the head of the crown which in turn forms the other support zone capable of cooperating with the second end of this spring 19.

In this embodiment, it will be understood that such a control device 1 makes it possible to implement a method for controlling the watch and in particular for controlling at least one function of this watch. To this end, the method provides a process for activating this device 1 to control a watch function. During this process, the crown 2 is manipulated from its initial position to its control position, which is the position in which the crown 2 and in particular the crown head 7 is arranged closest to the middle 6. During this manipulation, the crown 2 is axially moved from its initial position in the direction of the through-hole 12 by compressing the spring 19 arranged between the head 7 of the crown 2 and the compression part 20 included in this crown 2. When the free end of the drive element 8 of this crown 2 is located close to or in contact with the outer peripheral wall 15a of the casing ring 29 of the control member 4, the crown 2 is then set in rotation to introduce this free end into at least one passage zone 24a, 24b of the through-hole 12. As previously mentioned, in the present embodiment, through-hole 12 may comprise two passage zones 24a, 24b intended to control two different watch functions. In this context, the crown 2 is then set in rotation in a first direction in order to select the passage zone 24a, 24b relative to the function to be controlled and to introduce this free end into this zone until the shoulder 16 connecting the fixing and insertable portions 9a, 9b of the drive element 8 comes into abutment against the external peripheral wall 15a of the casing ring 29. Once this shoulder 16 is in abutment against the outer peripheral wall 15a, the crown 2 is then manipulated in a second direction opposite/contrary to the first, to be configured in its control position in order to cooperate with the coupling element 13 of the ring 10. In the latter configuration, this crown 2 is then in the control position and can cooperate with the coupling element 13 of the ring 10 via the coupling portion 9c of the drive element 8 of the crown 2. It should be noted that in this control position, the coupling portion 9c of the drive element 8 of the crown 2 is held in abutment against the inner peripheral wall 15b of the casing ring 29 by the action of the spring 19, which exerts an elastic return force on the crown 2. Note that the control position is the one in which the free end of the drive element 8 and therefore of the crown 2 is engaged in the through-hole 12 and/or the free end cooperates with or is coupled to the ring 10. In other words, the control position is the position in which the main part 23a of the free end of the crown 2 is arranged in the through-hole 12.

Subsequently, manipulation of the crown 2 in the second direction of rotation causes the ring 10 to move in the support zone of the casing ring 29 as a result of the cooperation of the coupling portion 9c of the drive element 8 of the crown 2 with the coupling element 13 of the ring 10. This movement is carried out until the coupling element 13 is in contact with the corresponding stop element 28 of the cooperation zone 11. Such a movement of the ring 10 generates, via its connecting element, tension on the first elastic return element 18 arranged in the housing defined in the support zone below this ring 10. During this movement, the actuating element 30 of the ring 10 actuates the corresponding pivoting element 14 by causing a change of position of this pivoting element 14 towards an activation position in which a portion of this element 14 protrudes from the inner peripheral wall 15b of the casing ring 29 in order to interact with the corresponding mechanism of the movement for the implementation of the controlled function. Subsequently, once the crown 2 has been manipulated, the ring 10 is automatically put in its rest position by the action of the first elastic return element 18, which then returns to its rest shape. This putting of the ring 10 in its rest position causes the pivoting element 14 to be automatically put in its initial position, as it is no longer constrained by the actuating element 30 of the ring 10.

Subsequently, the method may include a process of deactivating the device 1, during which the crown 2 is manipulated from its control position back to its initial position. In this context, the crown 2 is then set in rotation in the first direction until the coupling portion 9c of the drive element 8 is positioned opposite the eccentric portion 25a, 25b of the corresponding passage zone 24a, 24b of the through hole 12 of the casing ring 29. In such a configuration, the spring 19 arranged in the crown 2 resumes its rest shape, causing an axial movement of the crown 2, which results in the free end of the drive element 8 being extracted from this passage zone 24a, 24b, and which automatically puts this crown 2 in its initial position.

Furthermore, it should be noted that in this description “substantially perpendicular” or “substantially perpendicularly” means “strictly perpendicular” or “essentially perpendicular”.

The invention has been described above only by way of example. It goes without saying that modifications could be made without departing from the scope of the claimed invention. By way of example, it will be understood that the control device 1 may be configured to implement more than the two functions described here in this embodiment, in particular by comprising a casing ring 29 in which the through-hole 12 comprises more than two passage zones for the free end of the drive element 8 of the crown 2.

### PARTS LIST

1. Control device
2. Crown
3. Support part
4. Control unit
5. Watch case
6. Middle
7. Crown head
8. Drive element
9a. Fixing portion
9b. Insertable portion
9c. Coupling portion
10. Ring
11. Cooperation zone
12. Through-hole
13. Coupling element
14. Pivoting element
15a. Outer peripheral wall
15b. Inner peripheral wall
16 Shoulder on the outer surface of the drive element
17. Through-opening
18. First elastic return element
19. Spring
20. Compression part
21. Stem
22. Shoulder formed on the compression part
23a. Main part of the insertable portion
23b. Terminal part of insertable portion
24a. First passage zone
24b. Second passage zone
25a. Eccentric portion of the first passage zone
25b. Eccentric portion of the second passage zone
26. Central portion common to the first and second passage zones
27. Region of the through-opening close to the pivoting element
28. Stop elements in the cooperation zone
29. Casing ring
30. Ring actuating element
31. Tension member

1. A control device (1) for a watch comprising a crown (2) mounted movably in a support part (3) of this device (1) and configured to be fixed with respect to the movement of the watch, said crown (2) being configured to be displaced axially with respect to its longitudinal axis (A) towards a control position in which a rotational drive element (8) of said crown (2) is configured to cooperate with a ring (10) mounted movably in a casing ring (29) of a control member (4) of said device (1), said ring (10) being configured to actuate a mechanism of the watch movement implementing a function of the watch when the crown (2) is rotated.

2. The control device (1) according to claim 1, wherein the casing ring (29) comprises on its inner peripheral wall (15b) a cooperation zone (11) between the ring (10) and the drive element (8), said zone (11) comprising stop elements (28) defining a displacement travel of this ring (10) mounted movably in the casing ring (29).

3. The control device (1) according to claim 1, wherein the drive element (8) has a free end comprising a coupling portion (9c) for coupling to the ring (10).

4. The control device (1) according to claim 1, wherein the drive element (8) has a free end comprising a coupling portion (9c) for coupling to the ring (10), this coupling portion (9c) extending substantially perpendicularly to an outer surface of said free end.

5. The control device (1) according to claim 1, wherein the casing ring (29) comprises a through-hole (12) interconnecting inner and outer peripheral walls (15a, 15b) of said casing ring (29), the hole (12) having a passage zone (24a, 24b) for said free end.

6. The control device (1) according to claim 1, wherein the casing ring (29) comprises a through-hole (12) interconnecting inner and outer peripheral walls (15a, 15b) of said casing ring (29), the hole (12) having a passage zone (24a, 24b) for said free end, the passage zone (24a, 24b) comprising a central portion (26) configured for the arrangement of a main part (23a) of the free end in said hole (12) and an eccentric portion (25a, 25b) forming a passage allowing the coupling portion (9c) to pass through the body of said casing ring (29).

7. The control device (1) according to claim 1, wherein the ring (10) comprises an actuating element (30) for a pivoting element (14) of the member (4) configured to actuate the mechanism implementing the function of the watch.

8. The control device (1) according to claim 1, wherein the control member (4) comprises a first elastic return element (18) configured to automatically return the ring (10) to a rest position.

9. The control device (1) according to claim 1, wherein the control member (4) comprises a first elastic return element (18) configured to automatically return the ring (10) to a rest position, the drive element (8) being integral with a head (7) of the crown (2).

10. A watch comprising the control device (1) according to claim 1.
